(19) United States
(12) Patent Application Publication
(10) Pub. No.: US 2026/0158537 A1
(43) Pub. Date: Jun. 11, 2026

(54) DEVICE & METHOD FOR ROLLING A STEEL STRIP

(71) Applicant: ArcelorMittal, Luxembourg (LU)

(72) Inventors: Maurice TORNICELLI, Maizières-Les-Metz (FR); Maxime LAUGIER, MONTIGNY LES-METZ (FR); Odile CARRIER, Metz (FR)

(21) Appl. No.: 18/577,295

(22) PCT Filed: Jul. 27, 2022
(86) PCT No.: PCT/IB2022/056912

§ 371 Date: Jan. 8, 2024

(30) Foreign Application Priority Data
Jul. 28, 2021 (WO) PCT/IB2021/056867

(51) Int. Cl. B21B 45/02; B21B 1/22

(52) U.S. Cl. CPC B21B 45/02; B21B 1/22; B21B 2001/221

(57) ABSTRACT

The present invention relates to a cold rolling stand for rolling a metallic strip having: a pair of work rolls determining a roll bite, a first set of spraying devices able to spray a first lubricant onto said pair of work rolls, a second set of spraying devices able to spray a second lubricant upstream of said work rolls, a collector able to collect the first and second lubricants, an inversion system, a tank connected to the collector, to the first set of spraying devices and to the inversion system, the tank being able to contain the sprayed lubricant, the inversion system being connected to the second set of spraying devices. This invention also relates to a cold rolling process.

The present invention relates to a rolling equipment and a rolling method improving the rolling condition of all steel grades during cold rolling. More particularly, it can be used in a rolling mill comprising four to six rolling stands. On one hand, the invention improves the rolling mill capability to produce the harder and thinner steel grades such as the advanced high strength steel (AHSS) and electrical steels. On the other hand, among other advantages, it permits a decrease in manufacturing cost by avoiding oil over-consumption when an intensive use of a flexible lubrication becomes essential as is the case for all increasingly thinner and harder products to be rolled.

### BACKGROUND

Conventional lubrification systems with recirculation were usually used in a sheet cold rolling mill, as illustrated in FIG. 1, wherein a strip S is generally passed through four to six rolling stands (noted S1 to S5) in order to reduce its thickness and achieve the desired mechanical properties. A rolling stand generally comprises a pair of work rolls 1 defining a roll bite (nip) 2, at least a pair of back-up rolls 3 and a lubricating system 4. The lubricating system is generally composed of a series of nozzles 5 spraying an oil-in-water emulsion onto the rolls 1 and the strip S and pipes connected to an oil-in-water emulsion tank 6. Generally, said oil-in-water emulsion has an oil content of 0.5% to 3%, with a mean oil droplet size of 1 to 10 μm. Moreover, said oil-in-water emulsion may comprise additives such as antioxidants, surfactants and anti-wear-extreme-pressure (AW-EP). The lubricating system has also the task of cooling the rolls and the strip which heats up due to the thermomechanical deformation. In this case, once the lubricant has fulfilled its task, it is collected by collecting means 7, stored in a tank 6 and flows to the lubricating system 4. Lubricant and water are continuously supplied to the lubricating system 4 in a recirculating way. The management of conventional lubrification systems with recirculation needs addition of fresh oil and water, directly done into the tank 6 to compensate the oil and water losses due to several factors such as: water evaporation, oil stuck on the strip, the removal of particles on which oil is stuck, skimming operation, etc. The sum of all said oil losses determines the natural oil consumption of the tandem rolling mill.

### SUMMARY OF THE INVENTION

This conventional lubrication system where the lubrication and the cooling are fully coupled, requires operating with a direct oil-in-water emulsion being necessarily stable, due to a retention time of the emulsion being generally from 15 to 35 minutes, a low oil concentration and a small particle size. Moreover, the cooling requires a large volume of emulsion which does not allow the performance of the lubrication to be adjusted to the characteristic timescales of cold rolling process which makes it inoperative for an optimal real control of friction level. The main advantage of this type of lubrication has been economical due to a low oil consumption. But this lubrication has been considered to be very insufficient to meet the new challenges: high rolling speeds, increasingly harder and thinner materials, energy process optimization. This is the reason why advanced lubrication systems such as Flexible-Lubrication or Hybrid-Lubrication has been developed as explained in [M. Laugier, M. Tornicelli, C. Silvy-Leligois, D. Bouquegneau, D. Launet, J A Alvarez, “Flexible lubrication concept, the future of cold rolling lubrication”, extended paper version, Journal of Engineering Tribology, Part J, 2011].

The development of new steel grades and products, being harder and thinner, impacts greatly the cold rolling mills because they require greater rolling forces. It is due to the fact that all other factors being equal, the harder and thinner the steel sheet, the higher the rolling force required. Moreover, for fundamental reasons already widely explained in cold rolling literature, the required rolling force depends also upon numerous other parameters such as those related to rolling working conditions: front and back tensions, thickness reduction, roll bite contact length. In particular the required rolling force depends on the friction between the rolled product and the work rolls, which can be characterized by a friction coefficient, u. During the cold rolling operation, all other factors being equal, the higher the friction coefficient, the higher the required rolling force. Consequently, having too much uncontrolled high friction coefficient induces losses of rolling force capacity. It has been demonstrated that for a strip yield stress over 750 MPa and for a strip thickness lower than 2 mm, the sensitivity of rolling force to friction coefficient drastically increases and is almost exponential as explained in [M. Laugier, M. Tornicelli, J. Cebey, D. Lopez Peris, A. Devolder, R. Guillard, F. Kop «Flexible lubrication for controlling friction in cold rolling, crucial to be successful for the AHSS Challenge >, METEC & 2nd ESTAD 15-19 Jun. 2015 Düsseldorf, Germany]. As a consequence, the typical friction variations occurring with conventional lubrications induce an important loss of capacity due to a rolling force saturation occurring for classical sheet tandem rolling mills when the required rolling force reaches the technological limit about 3 000 tons. For instance, it has been shown that a friction coefficient established at 0.050 instead of 0.040 is clearly detrimental on tandem mill capability as this friction variation could increase the required rolling force of several hundred tons. It has then become crucial to control precisely the friction coefficient at the lowest possible level inside a very narrow window. This precise friction coefficient control can be only obtained using the more advanced lubrications systems such as Flexible Lubrication.

Furthermore, the friction coefficient in an optimum range permits an attainment of a satisfying surface quality and can prevent seizure, avoid detrimental behaviour, such as chattering, and reduce energy consumption. This the reason why advanced lubrications have become crucial for the rolling process in order to enable the production of harder and thinner products. In summary, due to a wide diversity of the produced steel grades in the cold rolling mills and for all the above-mentioned reasons, the lubrication system needs to be flexible.

As illustrated in FIG. 2, during cold rolling, when an oil-in-water emulsion 8 is sprayed on a steel strip S or directly in the convergent zone of the roll bite entry, the oil adheres onto the strip S and the work roll 1, forming a lubricant film 10 supplying the rolls bite entry. It is assumed, thanks to the mixed lubrication theory, that the friction coefficient μ in the roll bite can be defined by the following equation: μ=μ_{L}[1−λ_{H}]+λ_{H}·μ_{H}, where μ_{L} is the friction's boundary component, typically between 0.100 and 0.120, μ_{H} is the friction's hydrodynamic component, typically between 0.008 and 0.012. The ratio λ_{H}≈h_{L}/h_{S} determines the lubrication regime inside the roll bite, wherein hr is the entry film thickness and hs corresponds to a combined surfaces roughness considering the work roll roughness and the strip roughness. It can be noticed that the work roll roughness is a dominant parameter and it evolves during rolling operation due to the so-called rolls wear phenomenon. This is explained in the previously cited articles. It is then obvious that controlling the entry film thickness is a key parameter to control the friction coefficient. The entry film thickness hi supplying the rolls bite can have three origins as it is shown in FIG. 2. A first film 10 formed by the strip plate-out mechanisms, a second film 11 formed in the convergent zone by dynamic concentration mechanism, and possibly a third film 12 formed by platting-out on work roll surface and/or, recycled film from the roll bite exit, passing through the back-up roll-work roll contact as explained in [R. Guillaument, S. Vincent, J. Duclos, M. Laugier, P. Gardin, Plat-out modelling for cold rolling system lubricated with O/W emulsion. ICTMP, Nice June 2010], and [Wilson, W. R. D., Sakaguchi, Y., and Schmid, S. R., “A Dynamic Concentration Model of Emulsions,” Wear, v. 161, 1993, pp. 207-212]. It is generally assessed that the third film does not have a significant contribution to the hydrodynamic component in comparison to the first and second films.

Up to now, all advanced lubrications such as flexible lubrication with recirculation uses a combination of two lubrication systems as shown in FIG. 3. A first recirculating system 13 achieves minimal lubrication by applying a stable oil-in-water emulsion having a low oil concentration and a small particle size. The recirculation system uses a large volume of emulsion because it achieves the cooling function of the strip and the rolls. A second system 14 is entirely dedicated to the flexible lubrication and thus uses a much smaller emulsion volume, in comparison with the first recirculating system 13, and an unstable emulsion with a large particle size. The flexible lubrication systems use the various oil films formation mechanisms, mainly the strip plate-out mechanism by acting on the sprayed emulsion characteristics: oil concentration, oil particle size and/or the spraying parameters: emulsion flow rate, ballistic parameters such as the sprayed emulsion speed impact on the solid surfaces. For lubrication systems using a static mixer, the parameters of the second system can be varied within seconds to modify the plate-out mechanism, e.g. the film thickness and its properties. For example, the oil concentration can vary from 0% to 30%, the emulsion flow rate can vary from 5 to 30L. min⁻¹. It enables control of the oil entry film thickness and thus the friction coefficient in the roll bite.

JP 2002 172 412, as illustrated in FIG. 4, discloses a hybrid lubrication system. This patent discloses a cold rolling method aiming to prevent the occurrence of chattering caused by insufficient lubrication at high rolling speed. The installation comprises a circulating rolling lubricant supply system 15 and a separate rolling lubricant supply system 16. The circulating rolling lubricant supply system 15 comprises spraying means 5, a tank 6 and collecting means 7, permitting to collect the sprayed rolling lubricant and transfer it to the tank. The separate rolling lubricant supply system 16 comprises a tank 3 and spraying means 5′. The separate system is not always used but is preferentially used when the circulating rolling oil cannot maintain the friction coefficient in the predetermined suitable range, e.g. for high strip speed and/or AHSS.

Nowadays, the advanced lubrications systems, e.g. the Flexible lubrication and the Hybrid lubrication, permit efficient regulation of the friction coefficient whatever the concerned production type and thus stable cold rolling in a precise optimized friction coefficient window, e.g. in the range of 0.015 to 0.030.

However, such a solution has several downsides. Even if the same oil is used for the two lubrication systems, the used emulsions strongly differ in characteristics. Moreover, the characteristics of the sprayed emulsion by the second system, e.g. the flexible one, are necessarily highly variable. Furthermore, some of the emulsion from the second spraying system and in particular the quantity of oil which has not adhered to the sheet is recovered in the tank of the first recirculating system. This can induce a limitation in use with time or issues for the management of the recirculated lubrication system partly because the properties and stability of the recirculated emulsion stored in tank 6 and sprayed by the spraying means 5 would be negatively impacted. It is due to the fact that when the volume of the sprayed emulsion of the additional system compared to the recirculated volume of lubricant is above a threshold, the recirculated emulsion can be destabilized. For example, it can flocculate, coalesce or break and can become overconcentrated. Furthermore, this problem would be even greater if such a flexible system would be used in several rolling stands because the flow of emulsion sprayed would be even greater compared to the natural consumption of the tandem mill. As a result, this solution cannot be used intensively, e.g. on every stand without restriction with time period use.

In EP 1 193 004 B1, the management of oil content in the main recirculated emulsion tank with hybrid lubrication is ensured through:
the addition of higher concentrated lubrication from a separate tank when oil additions cannot compensate the natural oil consumption of the mill
addition of dilution water when oil additions are higher than natural oil consumption of the mill
and eventually emulsifier additions depending on oil properties.

However, it is not adapted for circuit management with flexible lubrication in case of intensive use. Moreover, control of oil content in the recirculated circuit through addition of dilution water requires sufficient emulsion volume to compensate for an intensive use of FL additions, and the circuit management of the circuit can become difficult and more expensive. Furthermore, chemical treatments can be required in the prior art and the formulation needs to be known to adapt the treatments, especially for intensive use.

A purpose of this invention is to solve the aforementioned problem. The present invention provides a cold rolling stand for rolling a metallic strip S comprising:
a pair of work rolls 1 determining a roll bite 2,
a first set of spraying devices 17 able to spray a first lubricant onto said pair of work rolls 1,
a second set of spraying devices 18 able to spray a second lubricant 0.5 to 4 meters upstream of said work rolls 1 onto said strip,
collecting means 7 able to collect said first and second lubricants,
an inversion system 19,
a tank 20 connected to said collecting means 7, to said first set of spraying devices 17 and to said inversion system 19, said tank 20 being able to contain said sprayed lubricant,
said inversion system 19 being connected to said second set of spraying devices 18.

### BRIEF DESCRIPTION OF THE DRAWINGS

Other characteristics and advantages of the invention will become apparent from the following detailed description of the invention.

To illustrate the invention, various embodiment of non-limiting example will be described, particularly with reference to the following figures:

FIG. 1 illustrates a first embodiment of a cold rolling mill as known in the state of the art.

FIG. 2 illustrates an oil film between a strip and a work roll.

FIG. 3 illustrates a second embodiment of a cold rolling mill as known in the state of the art.

FIG. 4 illustrates a third embodiment of a cold rolling mill according to the cited prior art

FIG. 5 illustrates an embodiment of the present invention.

FIG. 6 illustrates the composition and the structure of the entering and exiting emulsion of an inversion system.

FIG. 7 illustrates an embodiment of the present invention comprising a system providing an aqueous phase to the third set of spraying devices.

FIG. 8 illustrates an embodiment of a mill of the present invention.

FIG. 9 illustrates a second embodiment of a mill of the present invention.

FIG. 10 illustrates an embodiment of the steps of the cold rolling method according to the present invention.

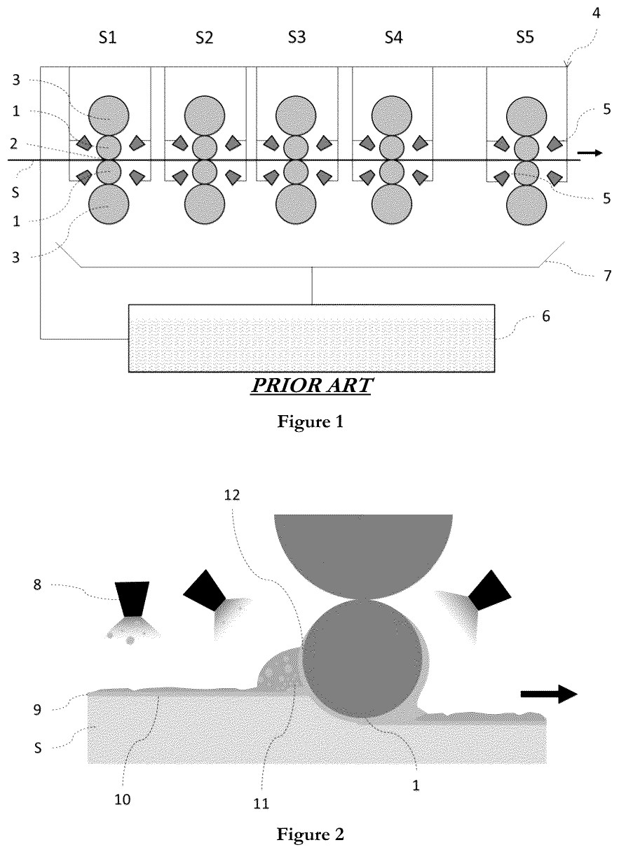

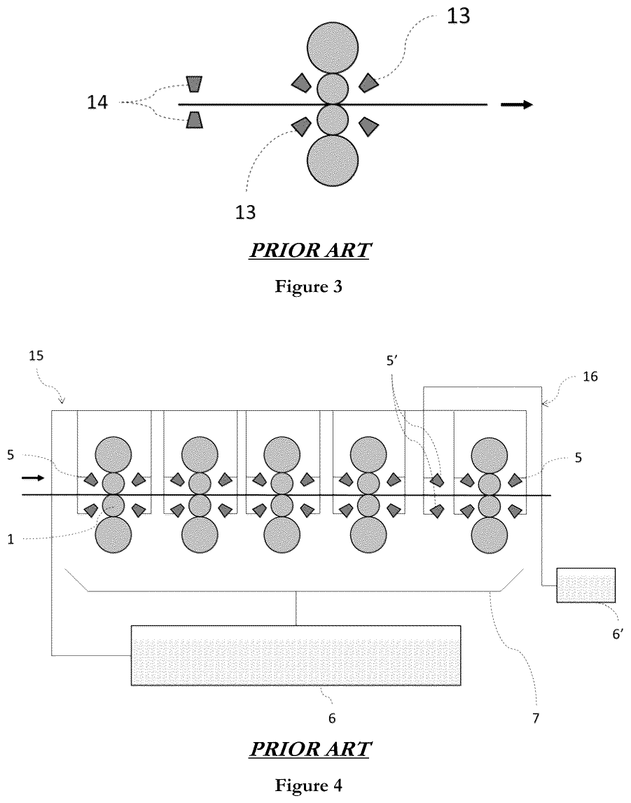

### DETAILED DESCRIPTION

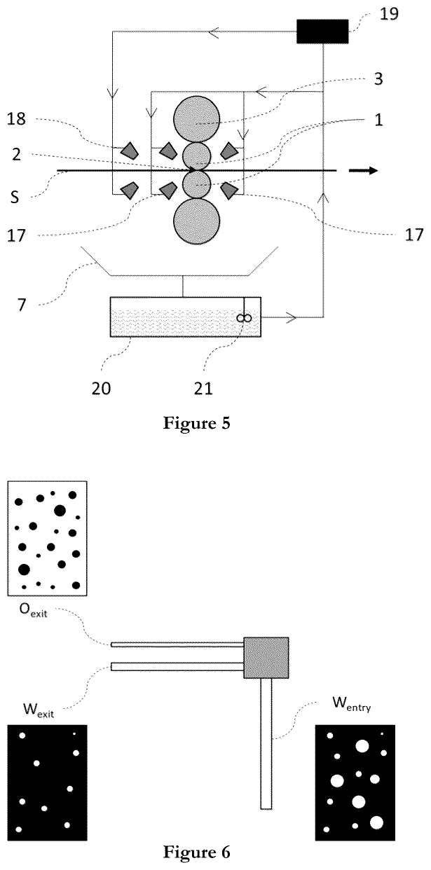

As illustrated in FIG. 5, the invention relates to a cold rolling stand for rolling a metallic strip S comprising:
a pair of work rolls 1 determining a roll bite 2,
a first set of spraying devices 17 able to spray a first lubricant onto said pair of work rolls 1,
a second set of spraying devices 18 able to spray a second lubricant 0.5 to 4 meters upstream of said work rolls 1 onto said strip,
collecting means 7 able to collect said first and second lubricants,
an inversion system 19,
a tank 20 connected to said collecting means 7, to said first set of spraying devices 17 and to said inversion system 19, said tank 20 being able to contain said sprayed lubricant,
said inversion system being connected to said second set of spraying devices 18.

In the following specification, the expressions «downstream» and «upstream» are to be understood relative to the path of the metal strip. Also, the terms “entry side” and “exit side” are to be understood relative to the path of the running metal strip. Moreover, the terms lubricant refers to any lubricating emulsions, such an oil-in-water emulsion, a water-in-oil emulsion, a water-in-oil-in-water emulsion.

As illustrated in FIG. 5, where the running metal strip runs from the left to the right, the “entry side” of the cold rolling stand is the side on the left of the roll bite 2 and the “exit side of the cold rolling stand is the side on the right of the roll bite 2.

As illustrated in FIG. 5, the first set of spraying devices 17 is preferably able to spray a first lubricant onto the pair of work rolls 1 and onto the strip being rolled. Preferably, the first set of spraying devices comprise series of nozzles positioned above and under said metallic strip S. Preferably, the first set of spraying devices 17 are composed of spraying devices positioned upstream and downstream of the roll bite 2, i.e., respectively on the entry side and the exit side. Alternatively, the first set of spraying devices is composed of spraying devices positioned only upstream of the roll bite 2, e.g. only on the entry side.

The second set of spraying devices 18 is preferably able to spray a second lubricant upstream of the roll bite and onto the strip being rolled. The second set of spraying devices is positioned on the entry side of the cold rolling stand.

The second set of spraying devices is able to spray the second lubricant 0.5 to 4 meters upstream of said work rolls onto the strip, i.e. 0.5 to 4 meters upstream of the roll bite 2 of the pair work rolls 1. Even more preferably, said second set of spraying devices is able to spray the second lubricant 1 to 3 meters upstream of said work rolls onto the strip.

Preferably, the second set of spraying devices is not able to spray the second lubricant onto the work rolls.

Preferably, said second set of spraying devices is composed of series of nozzles positioned above and under said metallic strip. For example, the second set of spraying devices can be placed from 1 meter to 3 meters upstream of the roll bite.

Preferably, said second set of spraying devices comprises mixers able to mix two fluids, for example an oil-in-water emulsion and an aqueous phase forming a water-in-oil-in-water emulsion. Even more preferably, said second set of spraying devices comprises a static mixer.

Optionally, said first set of spraying devices comprises mixers able to mix two fluids such as static mixer.

The collecting means 7 primarily aims at collecting the first and second lubricants sprayed by the first and second sets of spraying devices. The collecting means might also collect undesirable particles such as iron fines, oil for the rolling stand bearings (e.g. Morgoil).

The inversion system 19 aims at producing, from an entering oil-in-water emulsion, an inverse water-in-oil emulsion containing a higher oil proportion than the entering emulsion and a second oil-in-water emulsion containing a smaller oil proportion than the entering emulsion.

The inversion system 19 can be composed of at least one of the following systems: a membrane, an evaporator and/or a decanter.

Preferably, said inversion system is configured to produce an inverse emulsion by means of overconcentration and/or by means of centrifugal force. Even more preferably, the inversion system comprises a centrifuge.

For example, as illustrated in FIG. 6 wherein the dark areas represent the water and the white ones represent the oil:
an oil-in-water emulsion flow, W_{ENTRY}, having an oil concentration between 0.5 and 5% enters the inversion system,
a water-in-oil emulsion flow, O_{EXIT}, having a 70 to 99% oil concentration exits said system,
an oil-in-water emulsion flow, W_{EXIT}, having an oil concentration smaller than the entry oil concentration exits said system.

The tank 20 is connected to said collecting means 7, to said first set of spraying devices 17 and to said inversion system 19. In other words, a fluid can be flown from the tank to the first set of spraying devices and to the inversion system. The fluid can be flown by using, for example pipes, pumps and valves. Preferably, the tank 20 comprises means 28 to homogenize its content. Preferably, an aqueous phase, such as water can be added to the tank. Even more preferably, a lubricant can be added to the tank.

The rolling stand can also comprise means, such as magnetic filters collecting the iron fines, to remove undesirable particles from the lubricants. Preferably, they are positioned downstream the collecting means 7 and/or the tank 20.

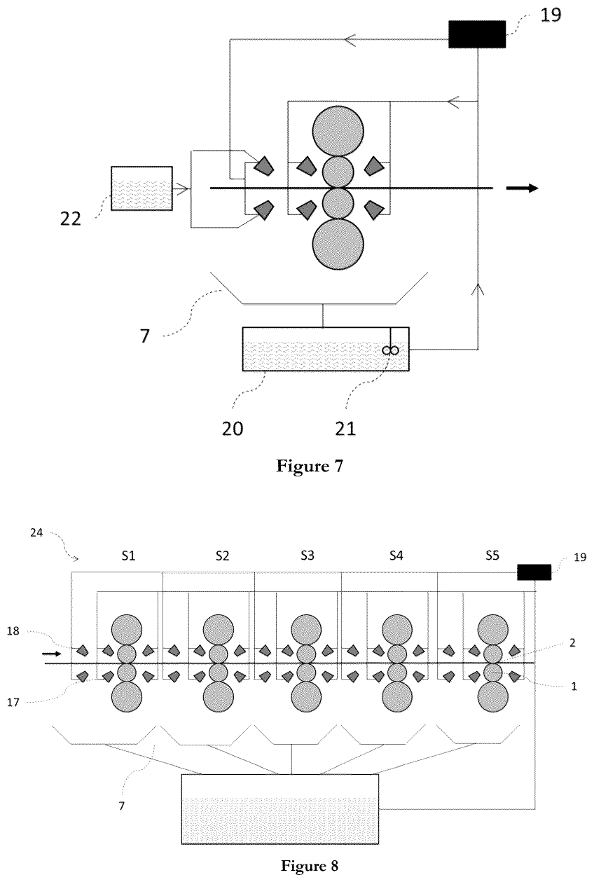

Preferably, said cold rolling stand comprises a system 22 (FIG. 7) able to provide an oil-in-water emulsion to the first set of spraying devices 17 and/or to the second sets of spraying devices 18. Preferably, the cold rolling stand also comprises a system able to provide an aqueous phase to the tank.

Preferably, as illustrated in FIG. 7, said inversion system is able to flow a water-in-oil emulsion to said second set of spraying devices 18. Such a system permits to spray a water-in-oil-in-water emulsion.

Preferably, said inversion system 19 comprises a centrifuge. A centrifuge permits efficient attainment of water-in-oil emulsion and oil-in-water emulsion. Even more preferably, said inversion system is able to flow a water-in-oil emulsion and an oil-in-water emulsion to said second set of spraying devices 18.

Preferably, said cold rolling stand comprises a decantation system downstream of the tank and upstream of said inversion system. Such a decantation system eases the separation of the two phases, the water-in-oil emulsion and the aqueous phase, in the inversion system. Even more preferably, a phase highly concentrated in oil of the decantation system is sent to the overconcentration system.

As illustrated in FIG. 8, the invention also relates to a cold rolling mill 24 comprising one to seven rolling stands (S1 to S5) wherein at least one of said rolling stand being as previously described. The second spraying device of a rolling stand are positioned downstream of the previous rolling stand.

Generally, the reduction rate and the speed of the strip passing in each rolling mill is different leading to different needs in terms of lubrication. Thus, the first and second lubricants sprayed may vary in terms of concentration for each rolling stand. Generally, the lubrication needs an increase at each stand, e.g. the stand S2 requires more lubricant than the stand S1 (e.g. a thicker lubricant film).

If the oil concentration and the oil droplet size of the different first lubricants collected and stored in the tank are too different, it could apparently reduce the lubrication effectiveness. To this end, the cold rolling mill preferably comprises two or more tanks or even more preferably a tank for each rolling stand. Having several tanks permits to reduce the composition difference between the collected lubricants.

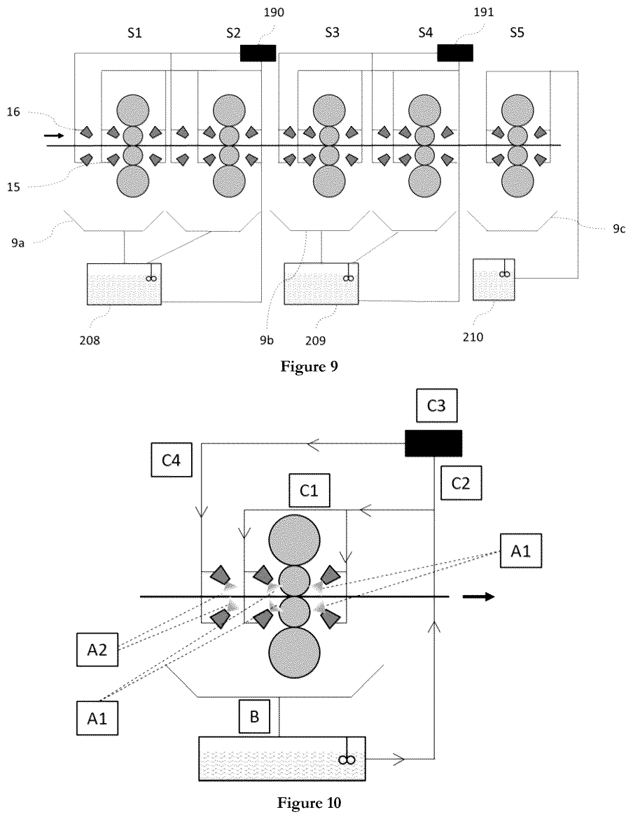

FIG. 9 exhibits a cold rolling mill comprising five cold rolling stands. The four first ones, S1 to S4, comprise a pair of work rolls, and first and second sets of spraying devices. The fifth rolling stand has only a first set of spraying devices. The cold rolling mill also comprises three tanks (208, 209, 210). The first one 208 being connected to the collecting means of the first and second stand, the second one 209 being connecting to the collecting means of the third and fourth stands and the third one 210 being connected to the collecting means of the fifth stand. The cold rolling mill also comprises two inversion systems. A first one 190 being connected to the tanks 208 and the second set of spraying devices of the stands 1 and 2. A second one 191 being connected to the tanks 209 and the second set of spraying devices of the stands 3 and 4. Moreover, the first sets of spraying devices of the stands S1 and S2 are connected to the first tank 208. The first sets of spraying devices of the stands S3 and S4 are connected to the second tank 209. The first set of spraying devices of the stand S5 is connected to the third tank 210.

Preferably, a decantation tank is connected to at least one the tank.

As schematically represented in FIG. 10, the invention also relates to a method permitting to roll a metallic strip, in a cold rolling stand as previously described, comprising the following steps:
A1) spraying a flow F1 of a first lubricant, having between 0.2 and 5% by weight of base oil by means of said first set of spraying devices onto said pair of work rolls 1,
A2) spraying a flow F2 of a second lubricant, having between 5 and 30% by weight of base oil,, by means of said second set of spraying devices onto the strip 0.5 to 4 meters upstream of said work rolls 1,
B) collecting said first and second sprayed lubricants by means of said collecting means 7 and flowing said first and second sprayed lubricants to said tank 20.
C1) supplying said first set of spraying devices with the lubricants from said tank 20,
C2) supplying said inversion system 19 with the lubricants from the tank,
C3) producing a water-in-oil emulsion by means of said inversion system 19,
C4) supplying said second set of spraying devices with the water-in-oil emulsion prepared in step B2).

The steps C1 and A1 permit flow of a portion of the lubricant contained in the tank to the first set of spraying devices permitting to spray, a flow F1, of the first lubricant onto the pair of work rolls. Preferably, in step A1), the first lubricant is sprayed onto the pair of work rolls and the strip being rolled. The first lubricant properties, such as the oil concentration and the size of the oil droplet can vary during the rolling process.

Moreover, after maintenance or if the tank is empty or, the first process is to fill the tank 20 with a first lubricant.

The steps C2 and C3 permit to produce a water-in-oil emulsion, as represented in FIG. 6, with a portion of the collected lubricants contained in the tank. The water-in-oil emulsion can be produced by any means.

The first and second lubricants are different which means that they differ in at least one of the following criteria: nature, composition, droplet size, temperature. Preferably, the second lubricant has a higher oil content than the first lubricant.

In the case where a decantation tank is placed downstream of the tank and upstream of the first set of spraying devices and of the inversion system, in the step C1, the first set of spraying devices is supplied with the lubricants from the decantation tank and/or the tank and in the step C2, the inversion system is supplied with the lubricants from the decantation tank and/or the tank. Moreover, an additional step is present wherein the tank supplies the decantation tank.

In the step B, the sprayed first and second lubricants are collected by the collecting means and stored in the tank.

Preferably, in step A1), said flow F1 is variable. Preferably, in step A2), said flow F2 is variable. It permits to vary the quantity of lubricants sprayed during the rolling process in function of the rolling conditions and of the steel grade being rolled.

Preferably, in step A1), said first lubricant has an oil droplet size between 1 and 15 um. Such a base oil concentration and/or such an oil droplet size permit to maintain the friction coefficient in an optimal range for most of the steel grades. So, during the rolling of strips not requiring a very low friction coefficient, such as the AHSS, the flow F2 of the second lubricant can be lowered.

Preferably, in step C3) said water-in-oil emulsion has at least 70% by weight of base oil.

Preferably, in step C4) an oil-in-water emulsion or water is also supplied to said second set of spraying devices and in step A2), a water-in-oil-in-water emulsion is produced and sprayed by said second set of spraying devices.

Even more preferably, in step C3), an oil-in-water emulsion and a water-in-oil emulsion are produced by means of said inversion system and in step C4), the second set of spraying devices is supplied with the water-in-oil emulsion and the aqueous phase produced in said step C3). It permits to reduce the water consumption.

Preferably, in step A2), said second lubricant is sprayed by means of said second set of spraying devices onto the strip 1 to 3 meters upstream of said work rolls 1.

Preferably, in step A2), said second lubricant has oil droplet size between 15 and 40 μm. Preferably, in step A2), said second lubricant has oil droplet size between 15 and 100 μm. Such a droplet size permits to increase the lubrication and thus maintain the friction coefficient at lower values. So the rolling of advanced high strength steel is eased.

Preferably, said collected lubricant is not thermally treated. Preferably, said collected lubricant is not chemically treated. When the lubricant undergoes at least one of such treatments, the lubricant is deteriorated reducing the lubrication. Moreover, such treatments, the energy required, and the generated by-products have a negative impact on the environment.

The claimed invention permits transformation of a useful amount of the low concentration and stable oil-in-water (o/w) emulsion of the first set of spraying devices in circulation into a multiple emulsion water-in-oil-in-water (w/o/w) emulsion which will be used in the second set of spraying devices, e.g. the flexible lubrication additional system.

For example, an inverse emulsion is made by inversion of the emulsion of the first lubrication system collected by the collecting means and stored in the tank. Then said inverse emulsion is used as an internal phase in combination of an aqueous phase as external phase to form a water-in-oil-in-water emulsion (w/o/w) and is sprayed by the second set of spraying devices. The water content in the inverse emulsion can be adjusted from a few percent up to 30% depending on the needed properties of the final w/o/w emulsion (e.g. stability, plate-out properties).

The invention presents the advantage of using only one oil to feed both lubrication systems (e.g. set of spraying devices), under different emulsion states to be adapted for different modes of roll-bite feeding (dynamic concentration or plate-out). It enables a more intensive use of the flexible lubrication system while reducing the addition of new fresh oil inside. Moreover, this is obtained without any chemical treatment and without over oil consumption in comparison with known lubrication system with recirculation. The only additions of fresh oil are made to compensate the natural consumption of the mill. The main lubricant losses are due to the lubricant loss on strip, evaporation and the removal of undesirable particles such as iron fines entrapping lubricant which can be considered as inherent to the process.

Furthermore, contrary to the existing state of the art, such as the patent JP 2002 172 412, wherein the separate rolling system is exclusively fed with fresh lubricant, in the present invention the second set of spraying devices is fed at least partly with recirculated lubricant. Consequently, the lubricant consumption is reduced and the stability of the recirculated lubricant in the tank is not negatively impacted in the present application compared to the existing prior art.

What is claimed is:

1-11. (canceled)

12. A cold rolling stand for rolling a metallic strip, the cold rolling stand comprising:
a pair of work rolls defining a roll nip;
a first set of sprayers able to spray a first lubricant onto the pair of work rolls;
a second set of sprayers able to spray a second lubricant 0.5 to 4 meters upstream of said work rolls onto the strip;
a collector able to collect the first and second lubricants,
an inversion system; and
a tank connected to the collector, to the first set of sprayers and to the inversion system, the tank being able to contain the sprayed first and second lubricants,
the inversion system being connected to the second set of sprayers.

13. The cold rolling stand as recited in claim 12 further comprising a supply able to provide an aqueous phase to the first set of sprayers or to the second set of sprayers.

14. The cold rolling stand as recited in claim 12 wherein the inversion system is able to flow a water-in-oil emulsion to the second set of sprayers.

15. The cold rolling stand as recited in claim 12 wherein the inversion system includes a centrifuge.

16. The cold rolling stand as recited in claim 12 further comprising a decantation system downstream of the tank and upstream of the inversion system.

17. A cold rolling mill comprising one to seven rolling stands, wherein at least one of the rolling stands is the cold rolling stand as recited in claim 12.

18. A method permitting rolling of a metallic strip, in the cold rolling stand as recited in claim 12, the method comprising the following steps:
A1) spraying a flow F1 of a first lubricant, having between 0.2 and 5% by weight of base oil via the first set of sprayers onto the pair of work rolls;
A2) spraying a flow F2 of a second lubricant, having between 5 and 30% by weight of base oil, via the second set of sprayers onto the strip 0.5 to 4 meters upstream of the work rolls;
B) collecting said first and second sprayed lubricants via the collector and flowing the first and second sprayed lubricants to the tank;
C1) supplying the first set of sprayers with the first lubricant from the tank;
C2) supplying the inversion system with the first and second lubricant from the tank,
C3) producing a water-in-oil emulsion via the inversion system; and
C4) supplying the second set of sprayers with the water-in-oil emulsion prepared in step C3).

19. The method as recited in claim 18 wherein in step C3) the water-in-oil emulsion has at least 70% by weight of base oil.

20. The method as recited in claim 18 wherein in step C4) an aqueous phase is also supplied to the second set of sprayers and in step A2), a water-in-oil-in-water emulsion is produced and sprayed by the second set of sprayers.

21. The method as recited in claim 18 wherein in step C3), an aqueous phase and a water-in-oil emulsion are produced by the inversion system and in step C4), the second set of sprayers is supplied with the water-in-oil emulsion and the aqueous phase produced in said step C3).

22. The method as recited in claim 18 wherein the collected first and second lubricants are not thermally treated.
